(19) United States
(12) Patent Application Publication
(10) Pub. No.: US 2025/0096435 A1
(43) Pub. Date: Mar. 20, 2025

(54) MULTI-STACK BATTERY CELLS WITH DIFFERENT TAB LENGTHS

(71) Applicant: GM GLOBAL TECHNOLOGY OPERATIONS LLC, DETROIT, MI (US)

(72) Inventors: Youngmin Chung, Troy, MI (US); Hwanchul Kim, Dryden, MI (US); Vincent Edward Herrman, Clawson, MI (US); Won-cheol Chang, Troy, MI (US); Jacob Trogan, Royal Oak, MI (US)

(21) Appl. No.: 18/469,778

(22) Filed: Sep. 19, 2023

(51) Int. Cl. H01M 50/538; H01M 50/534; H01M 50/536; H01M 50/548

(52) U.S. Cl. CPC H01M 50/538; H01M 50/534; H01M 50/536; H01M 50/548; H01M 2220/20

(57) ABSTRACT

Some embodiments disclosed herein are directed to battery cells with battery stacks having different tab lengths. Some embodiments may include a first battery stack that includes a first plurality of tabs extending from the first battery stack, and a second battery stack adjacent to the first battery stack that includes a second plurality of tabs extending from the second battery stack, where the second plurality of tabs are shorter than the first plurality of tabs. A weld plate may be welded to the first plurality of tabs and the second plurality of tabs without trimming the first plurality of tabs. Other embodiments may be disclosed or claimed.

The subject disclosure relates to battery cells. In particular, embodiments of the present disclosure relate to battery cells with battery stacks having different tab lengths.

Batteries are increasingly used in a wide variety of systems, from mobile computing devices to vehicles with electric motors. Some such batteries may have multiple cells, with each cell having two or more battery stacks, and each stack including multiple layers. Each layer may have a cathode tab and an anode tab extending from the layer, with the tabs in the layers of some batteries having a substantially uniform length. Battery cells with a large number (e.g., 100 or more) of layers have an issue with welding the tabs of the stacks to weld plates due to the length of the tabs. In particular, large numbers of tabs typically must be folded over the terminal of the battery during the weld process, which helps improves the efficiency of the weld process during cell assembly, and increases the contact between the terminal and the electrode.

However, in cells with large numbers of layers, portions of the tabs tend to extend beyond the weld plate when folded over, necessitating trimming of the extending portions which can leave behind residual particles, increase resistance by requiring additional welds, and reduces the overall efficiency of the battery production process. Among other things, embodiments of the present disclosure provide battery modules having adjacent battery stacks with different tab lengths to obviate the need for trimming the tabs of a battery during the welding process, thereby helping to improve the efficiency and reliability of battery modules.

### SUMMARY

In one exemplary embodiment, a battery cell is provided. The battery cell includes a first battery stack that includes a first plurality of tabs extending from the first battery stack, and a second battery stack adjacent to the first battery stack. The second battery stack includes a second plurality of tabs extending from the second battery stack, wherein the second plurality of tabs are shorter than the first plurality of tabs. The battery cell further includes a weld plate that is welded to the first plurality of tabs and the second plurality of tabs without trimming the first plurality of tabs.

In addition to one or more of the features described herein, the first plurality of tabs are a first plurality of cathode tabs, the second plurality of tabs are a second plurality of cathode tabs, and the weld plate is a first weld plate. The battery cell further includes a first plurality of anode tabs extending from the first battery stack, and a second plurality of anode tabs extending from the second battery stack. The second plurality of anode tabs are shorter than the first plurality of anode tabs, and the battery cell includes a second weld plate that is welded to the first plurality of anode tabs and the second plurality of anode tabs without trimming the first plurality of anode tabs.

In addition to one or more of the features described herein, the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

In addition to one or more of the features described herein, the first plurality of cathode tabs and second plurality of cathode tabs comprise aluminum.

In addition to one or more of the features described herein, the first plurality of anode tabs and second plurality of anode tabs comprise copper.

In addition to one or more of the features described herein, the first weld plate comprises aluminum and the second weld plate comprises copper.

In addition to one or more of the features described herein, the first plurality of tabs have a length of between about 10 mm and 30 mm, and wherein the second plurality of tabs are between about 30%-50% of the length of the first plurality of tabs.

In another exemplary embodiment, a system comprises a battery cell that includes a first battery stack that includes a first plurality of tabs extending from the first battery stack, and a second battery stack adjacent to the first battery stack. The second battery stack includes a second plurality of tabs extending from the second battery stack, and the second plurality of tabs are shorter than the first plurality of tabs. The battery cell further includes a weld plate that is welded to the first plurality of tabs and the second plurality of tabs without trimming the first plurality of tabs.

In addition to one or more of the features described herein, the first plurality of tabs are a first plurality of cathode tabs, the second plurality of tabs are a second plurality of cathode tabs, and the weld plate is a first weld plate. The battery cell further includes a first plurality of anode tabs extending from the first battery stack and a second plurality of anode tabs extending from the second battery stack. The second plurality of anode tabs are shorter than the first plurality of anode tabs. The battery cell further includes a second weld plate that is welded to the first plurality of anode tabs and the second plurality of anode tabs without trimming the first plurality of anode tabs.

In addition to one or more of the features described herein, the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

In addition to one or more of the features described herein, the first plurality of cathode tabs and second plurality of cathode tabs comprise aluminum.

In addition to one or more of the features described herein, the first plurality of anode tabs and second plurality of anode tabs comprise copper.

In addition to one or more of the features described herein, the first weld plate comprises aluminum and the second weld plate comprises copper.

In addition to one or more of the features described herein, the first plurality of tabs have a length of between about 10 mm and 30 mm, and wherein the second plurality of tabs are between about 30%-50% of the length of the first plurality of tabs.

In another exemplary embodiment, a vehicle includes an electric motor and a battery cell coupled to the electric motor. The battery cell includes a first battery stack that includes a first plurality of tabs extending from the first battery stack and a second battery stack adjacent to the first battery stack. The second battery stack includes a second plurality of tabs extending from the second battery stack, and the second plurality of tabs are shorter than the first plurality of tabs. The battery cell further includes a weld plate that is welded to the first plurality of tabs and the second plurality of tabs without trimming the first plurality of tabs.

In addition to one or more of the features described herein, the first plurality of tabs are a first plurality of cathode tabs, the second plurality of tabs are a second plurality of cathode tabs, and the weld plate is a first weld plate, the battery cell further includes a first plurality of anode tabs extending from the first battery stack and a second plurality of anode tabs extending from the second battery stack, where the second plurality of anode tabs are shorter than the first plurality of anode tabs. The battery cell further includes a second weld plate that is welded to the first plurality of anode tabs and the second plurality of anode tabs without trimming the first plurality of anode tabs.

In addition to one or more of the features described herein, the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

In addition to one or more of the features described herein, the first plurality of cathode tabs and second plurality of cathode tabs comprise aluminum, and wherein the first plurality of anode tabs and second plurality of anode tabs comprise copper.

In addition to one or more of the features described herein, the first weld plate comprises aluminum and the second weld plate comprises copper.

In addition to one or more of the features described herein, the first plurality of tabs have a length of between about 10 mm and 30 mm, and wherein the second plurality of tabs are between about 30%-50% of the length of the first plurality of tabs.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a diagram of a vehicle for use in conjunction with one or more embodiments of the present disclosure;

FIG. 2A is a diagram illustrating battery cell stacks with different tab lengths in accordance with embodiments of the present disclosure;

FIG. 2B is another diagram illustrating battery cell stacks with different tab lengths in accordance with embodiments of the present disclosure; and

FIG. 3 is a diagram illustrating an example of different battery tab lengths in accordance with embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a battery cell with an enhanced tab structure is provided. In some embodiments, the battery cell includes a first battery stack that includes a first plurality of tabs extending from the first battery stack, and a second battery stack adjacent to the first battery stack. The second battery stack includes a second plurality of tabs extending from the second battery stack and the second plurality of tabs are shorter than the first plurality of tabs. The battery cell further includes a weld plate that is welded to the first plurality of tabs and the second plurality of tabs without trimming the first plurality of tabs.

In this manner, embodiments of the present disclosure provide battery cells with multiple stacks that have different tab lengths. Stacks with large numbers of layers can be coupled to a common weld plate without having to trim any excess material from the tabs, thereby allowing battery modules containing such cells to be assembled more efficiently and without the risk of damage due to residual particles left behind from trimming of the tabs.

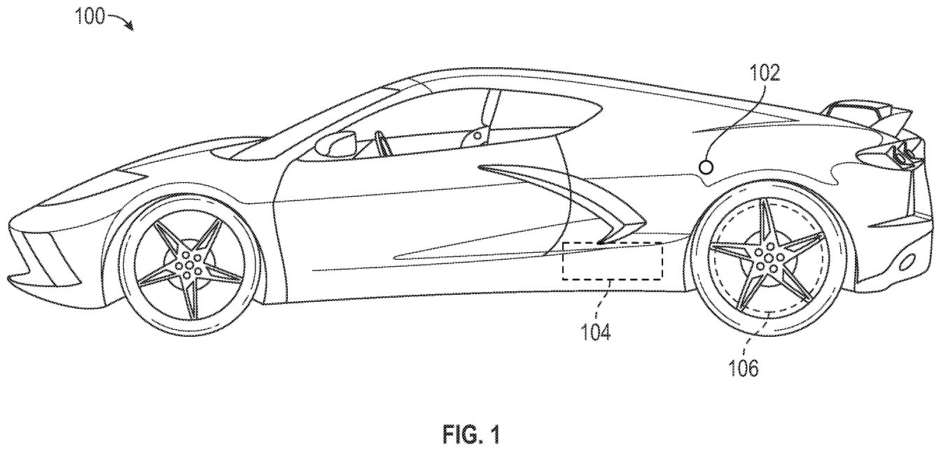

FIG. 1 provides a diagram of a vehicle 100 for use in conjunction with one or more embodiments of the present disclosure. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a high-voltage power source (i.e., a voltage source of at least 200 volts (V)), which is used to charge the battery 104. The electric motor 106 is configured to receive power from the battery 104 to provide propulsion for the vehicle 100.

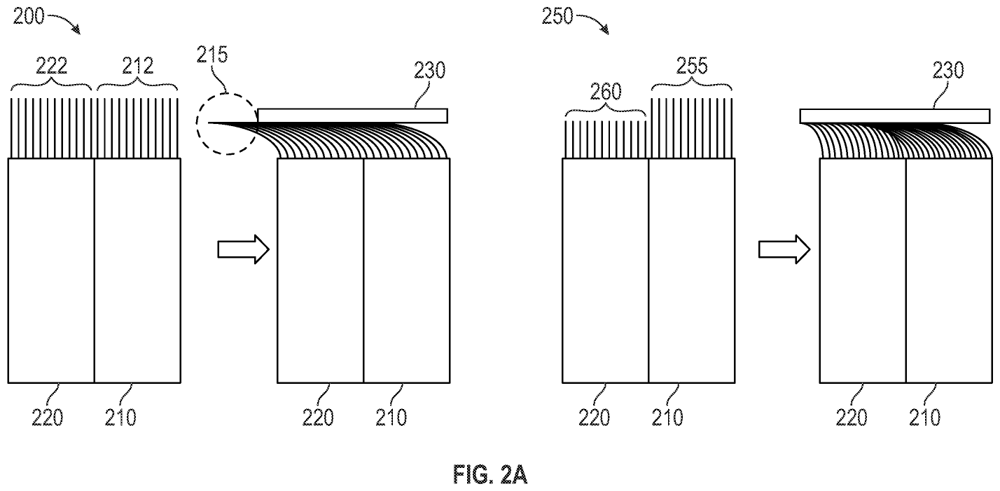

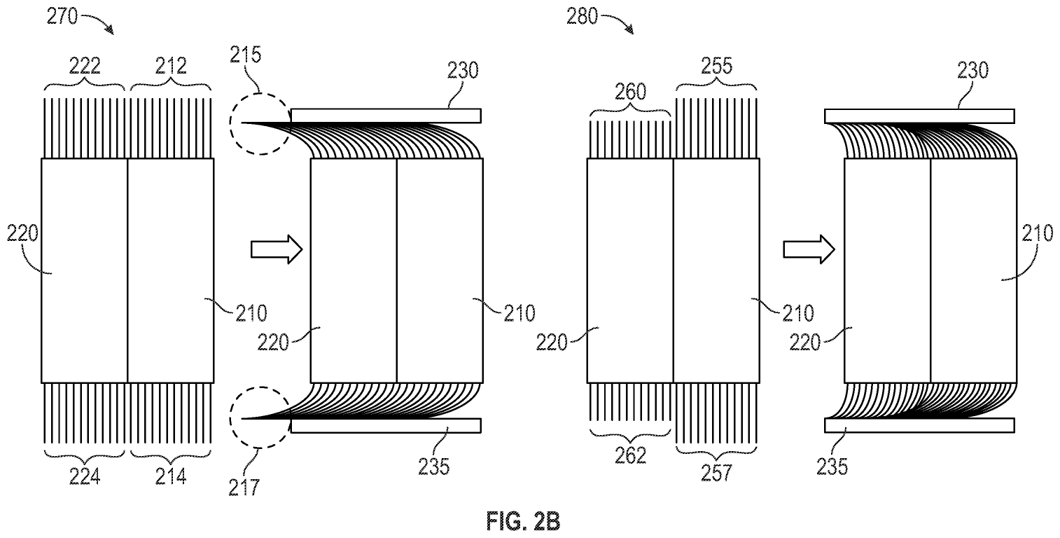

FIG. 2A illustrates battery cell stacks with different tab lengths in accordance with embodiments of the present disclosure. In this example, known configuration 200 illustrates an example of a first battery stack 210 and second battery stack 220 before and after coupling to a weld plate 230. In configuration 200, battery stack 210 includes a plurality of tabs 212 extending from the battery stack 210, and battery stack 220 likewise includes a plurality of tabs 222 extending from battery stack 220. In known configuration 200, the tabs 212 and 222 are substantially the same length, and when they are folded over in conjunction with being coupled to weld plate 230, a portion of the tabs extend beyond the edge of weld plate 230 (at section 215). This requires the portion at section 215 to be trimmed during production, increasing the complexity of assembling battery cells and modules using stacks 210 and 220, and also introducing a risk that particles from the trimmed section 215 will be left behind to potentially damage the battery.

In an embodiment of the present disclosure represented by configuration 250, by contrast, the first battery stack 210 has a first plurality of tabs 255, and second battery stack 220 has a second plurality of tabs 260, where the second plurality of tabs 260 are shorter than the first plurality of tabs 255. In configuration 250, the weld plate 230 is welded to the first plurality of tabs 255 and the second plurality of tabs 260 without trimming either the first plurality of tabs 255 or the second plurality of tabs 260.

The configurations 200 and 250 shown in FIG. 2A are illustrative of one set of tabs from battery stacks 210, 220, such as cathode tabs. FIG. 2B is another diagram illustrating battery cell stacks with different tab lengths in accordance with embodiments of the present disclosure. In this example, configurations 270 and 280 illustrate examples of battery cell stacks 210 and 220 with both cathode tabs and anode tabs.

In FIG. 2B, known configuration 270 illustrates battery stack 210 with cathode tabs 212 and anode tabs 214. Battery stack 220 has cathode tabs 222 and anode tabs 224. In this example of a known battery stack configuration, the cathode tabs 212, 222 and anode tabs 214, 224 are substantially the same length. This leads to a portion of the cathode tabs overhanging a first (cathode) weld plate 230 at section 215, and a portion of the anode tabs overhanging a second (anode) weld plate 235 at section 217 when the respective tabs are folded over to be welded to plates 230, 235. These extending portions must be trimmed, creating the efficiency and damage risks discussed above.

In configuration 280, by contrast, the first battery stack 210 has cathode tabs 255 and anode tabs 257, while the second battery stack 220 has cathode tabs 260 and anode tabs 262. Tabs 255 are longer than tabs 260 and tabs 257 are longer than tabs 262. A first (cathode) weld plate 230 is welded to the first plurality of cathode tabs 255 and the second plurality of cathode tabs 260 without trimming either the first plurality of cathode tabs 255 or the second plurality of cathode tabs 260. Likewise, a second (anode) weld plate 235 is welded to the first plurality of anode tabs 257 and the second plurality of anode tabs 262 without trimming either the first plurality of anode tabs 255 or the second plurality of anode tabs 262.

Cathode tabs 255, 260 may be any suitable length relative to each other. For example, in some embodiments cathode tabs 260 may be between about 30% and 50% of the length of cathode tabs 255. Cathode tabs 255, 260 may be formed from any suitable material or combination of materials. For example, in some embodiments cathode tabs 255, 260 may be formed from aluminum foil comprising at least 99.95% pure aluminum. Similarly, cathode weld plate 230 is preferably formed from aluminum, such as AL 3003 H14 or AL 1060 H14.

Anode tabs 257, 262 may likewise be any suitable length relative to each other, and anode tabs 257 do not necessarily need to be the same length as cathode tabs 255, nor must anode tabs 262 be the same length as cathode tabs 260. In some embodiments, anode tabs 262 are between about 30% and 50% the length of anode tabs 257. Anode tabs 257, 262 may be formed from any suitable material or combination of materials. For example, in some embodiments anode tabs 257, 262 are formed from copper foil comprising at least 99.95% pure copper. Likewise, anode weld plate 235 is preferably formed from copper, such as CU T2.

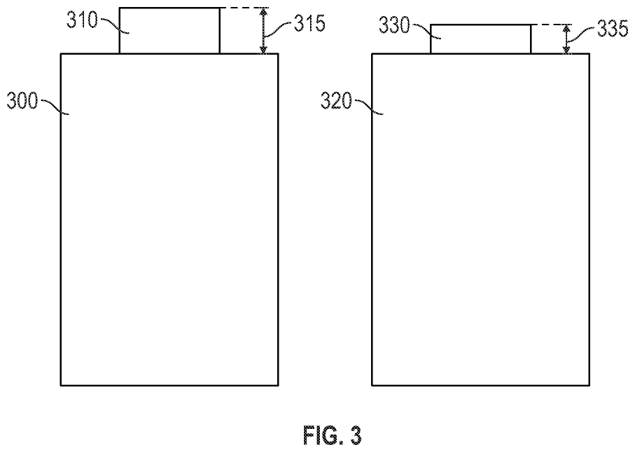

FIG. 3 is a diagram illustrating an example of different battery tab lengths in accordance with embodiments of the present disclosure. In this example, a first and second electrode illustrate tab lengths that may be used in conjunction with the first battery stack 210 and second battery stack 220 (respectively) shown in FIG. 2A and FIG. 2B. In FIG. 3, a first electrode has a coated area 300 and a tab 310 extending from the coated area 300. The tab 310 has a length 315, which may vary based on factors such as the size of the battery module and its application. In battery modules used in electric or hybrid vehicles (such as vehicle 100 in FIG. 1), the tab 310 may have a length 315 of between about 10 and 30 mm. A second electrode has a coated area 320 and a tab 330 extending from coated area 320. As with tab 310, the length of tab 330 may vary depending on a variety of considerations. In this example, tab 330 has a length 335 of between about 30% and 50% of the length 315 of tab 310.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a first battery stack that includes a first plurality of tabs extending from the first battery stack;
a second battery stack adjacent to the first battery stack, wherein the second battery stack includes a second plurality of tabs extending from the second battery stack, wherein the second plurality of tabs are shorter than the first plurality of tabs; and
a weld plate that is welded to the first plurality of tabs and the second plurality of tabs without trimming the first plurality of tabs.

2. The battery cell of claim 1, wherein the first plurality of tabs are a first plurality of cathode tabs, the second plurality of tabs are a second plurality of cathode tabs, and the weld plate is a first weld plate, the battery cell further comprising:
a first plurality of anode tabs extending from the first battery stack;
a second plurality of anode tabs extending from the second battery stack, wherein the second plurality of anode tabs are shorter than the first plurality of anode tabs; and
a second weld plate that is welded to the first plurality of anode tabs and the second plurality of anode tabs without trimming the first plurality of anode tabs.

3. The battery cell of claim 2, wherein the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

4. The battery cell of claim 2, wherein the first plurality of cathode tabs and second plurality of cathode tabs comprise aluminum.

5. The battery cell of claim 2, wherein the first plurality of anode tabs and second plurality of anode tabs comprise copper.

6. The battery cell of claim 2, wherein the first weld plate comprises aluminum and the second weld plate comprises copper.

7. The battery cell of claim 1, wherein the first plurality of tabs have a length of between about 10 mm and 30 mm, and wherein the second plurality of tabs are between about 30%-50% of the length of the first plurality of tabs.

8. A system, comprising:
a battery cell that includes:
a first battery stack that includes a first plurality of tabs extending from the first battery stack;
a second battery stack adjacent to the first battery stack, wherein the second battery stack includes a second plurality of tabs extending from the second battery stack, wherein the second plurality of tabs are shorter than the first plurality of tabs; and
a weld plate that is welded to the first plurality of tabs and the second plurality of tabs without trimming the first plurality of tabs.

9. The system of claim 8, wherein the first plurality of tabs are a first plurality of cathode tabs, the second plurality of tabs are a second plurality of cathode tabs, and the weld plate is a first weld plate, the battery cell further comprising:
a first plurality of anode tabs extending from the first battery stack;
a second plurality of anode tabs extending from the second battery stack, wherein the second plurality of anode tabs are shorter than the first plurality of anode tabs; and
a second weld plate that is welded to the first plurality of anode tabs and the second plurality of anode tabs without trimming the first plurality of anode tabs.

10. The system of claim 9, wherein the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

11. The system of claim 9, wherein the first plurality of cathode tabs and second plurality of cathode tabs comprise aluminum.

12. The system of claim 9, wherein the first plurality of anode tabs and second plurality of anode tabs comprise copper.

13. The system of claim 9, wherein the first weld plate comprises aluminum and the second weld plate comprises copper.

14. The system of claim 8, wherein the first plurality of tabs have a length of between about 10 mm and 30 mm, and wherein the second plurality of tabs are between about 30%-50% of the length of the first plurality of tabs.

15. A vehicle comprising:
an electric motor; and
a battery cell coupled to the electric motor, the battery cell comprising:
a first battery stack that includes a first plurality of tabs extending from the first battery stack;
a second battery stack adjacent to the first battery stack, wherein the second battery stack includes a second plurality of tabs extending from the second battery stack, wherein the second plurality of tabs are shorter than the first plurality of tabs; and
a weld plate that is welded to the first plurality of tabs and the second plurality of tabs without trimming the first plurality of tabs.

16. The vehicle of claim 15, wherein the first plurality of tabs are a first plurality of cathode tabs, the second plurality of tabs are a second plurality of cathode tabs, and the weld plate is a first weld plate, the battery cell further comprising:
a first plurality of anode tabs extending from the first battery stack;
a second plurality of anode tabs extending from the second battery stack, wherein the second plurality of anode tabs are shorter than the first plurality of anode tabs; and
a second weld plate that is welded to the first plurality of anode tabs and the second plurality of anode tabs without trimming the first plurality of anode tabs.

17. The vehicle of claim 16, wherein the first plurality of cathode tabs extend from a first end of the first battery stack, the second plurality of cathode tabs extend from a first end of the second battery stack, the first plurality of anode tabs extend from a second end of the first battery stack, the second plurality of anode tabs extend from a first end of the second battery stack, the first end of the first battery stack is opposite the second end of the first battery stack, and the first end of the second battery stack is opposite the second end of the second battery stack.

18. The vehicle of claim 16, wherein the first plurality of cathode tabs and second plurality of cathode tabs comprise aluminum, and wherein the first plurality of anode tabs and second plurality of anode tabs comprise copper.

19. The vehicle of claim 16, wherein the first weld plate comprises aluminum and the second weld plate comprises copper.

20. The vehicle of claim 15, wherein the first plurality of tabs have a length of between about 10 mm and 30 mm, and wherein the second plurality of tabs are between about 30%-50% of the length of the first plurality of tabs.
